(19) United States
(12) Patent Application Publication
(10) Pub. No.: US 2015/0205096 A1
(43) Pub. Date: Jul. 23, 2015

(54) TUNABLE LENS SYSTEM

(71) Applicant: ELECTRONICS AND TELECOMMUNICATIONS RESEARCH INSTITUTE, Daejeon (KR)

(72) Inventors: Sae Kwang NAM, Daegu (KR); Ki Uk KYUNG, Daejeon (KR); Sung Ryul YUN, Daejeon (KR); Bong Je PARK, Daejeon (KR); Sun Tak PARK, Incheon (KR)

(73) Assignee: ELECTRONICS AND TELECOMMUNICATIONS RESEARCH INSTITUTE, Daejeon (KR)

(21) Appl. No.: 14/600,369

(22) Filed: Jan. 20, 2015

(30) Foreign Application Priority Data
Jan. 20, 2014 (KR) 10-2014-0006720
Jun. 3, 2014 (KR) 10-2014-0067807

(51) Int. Cl. G02B 26/08; G02B 1/04

(52) U.S. Cl. CPC G02B 26/0875; G02B 1/041

(57) ABSTRACT

Provided herein a tunable lens system including a lens having a transparent solid material; and a lens focus adjuster disposed below the lens, and configured such that its area contracts or expands based on the electric energy applied and transforms the shape of the lens correspondingly to the contracted or expanded area so as to adjust the focus of the lens.

### CROSS-REFERENCE TO RELATED APPLICATIONS

The present application claims priority to Korean patent application numbers 10-2014-0006720, filed on Jan. 20, 2014 and 10-2014-0067807, filed on Jun. 3, 2014, the entire disclosure of which is incorporated herein in its entirety by reference.

### BACKGROUND

1. Field of Invention

Various embodiments of the present invention relate to a lens system, and more particularly, to a tunable lens system.

2. Description of Related Art

A lens is a tool for gathering or dispersing light. It may expand or reduce an image using the linear and refractive characteristics of light. However, a conventional lens is made on the basis of glass or plastic, and thus its shape cannot be transformed, which is a problem.

Therefore, in a lens system having the aforementioned lens, a scope tube is provided so that one or a plurality of lens can be moved in the axial direction to adjust the focal length of the lens. However, in such a lens system, the long length of the scope tube increases the total volume and also the weight, and thus it is impossible to efficiently adjust the focus distance of the lens in a limited space, which is a problem.

Accordingly, one type of tunable lens that is being widely used is a tunable lens provided with a liquid chamber having the shape of a lens into which liquid such as water or oil can be injected so that the shape of the lens can be transformed according to the amount of liquid injected.

Especially, when using a tunable lens system having the aforementioned tunable lens, it is possible to change the shape of the lens without moving the tunable lens in the axial direction in order to adjust the focal length. Thus, this kind of tunable lens system is able to be used in devices having small and narrow space.

However, when using the aforementioned conventional tunable lens system, if the surface of the tunable lens is torn, the liquid inside the tunable lens may leak, and the leaked liquid may cause corrosion or short circuit to the electric circuits near the tunable lens, or even affect human bodies.

Furthermore, in such the conventional tunable lens system, at least one reservoir and one injector for injecting the liquid to the chamber are always necessary near the tunable lens, thereby making it impossible to miniaturize the tunable lens system.

According to another type of tunable lens system, pressure is applied to the verge of a flexible lens so that its entire shape can be changed; thereby its focal length is changed. However, this type of tunable lens system requires some spaces around the lens. Therefore, it is not easy to miniaturize the lens system.

In order that the above tunable lenses function properly, an image needs to be clear even after the lenses are transformed. However, clear images may not be acquired due to various reasons, for example, spherical aberration. More specifically, light which passes through a lens and is refracted is not focused on one point but is focused on two or more points, or the light partially spreads. As a result, spherical aberration leads to overlapping or partially blurred images of a single object. However, none of the conventional tunable lens systems consider spherical aberration.

### SUMMARY

A purpose of various embodiments of the present invention is to provide a tunable lens system that is capable of adjusting the focal length of the lens with fast response without causing spherical aberration.

According to an embodiment of the present invention, it is provided a tunable lens system including a lens made from a transparent solid material; and a layer including electrodes to transform the shape of lens (also called as a focus adjuster) which also helps to clear spherical aberration problem. This layer sticks to the lens and configured such that its area contracts or expands based on the electric energy applied and transforms the shape of the lens correspondingly to the contracted or expanded area so as to adjust the focal length of the lens without spherical aberration.

Herein, the transparent solid material may include a thermoplastic material.

Herein, the transparent solid material may be flexible all the time or under limited conditions.

Herein, the lens before being transformed or its surface may have a parabolic shape.

Herein, the lens after being transformed or its surface may have a parabolic shape with the help of a focus adjuster layer.

Herein, the lens focus adjuster may include at least one upper electrode layer, a transforming layer, and at least one lower electrode layer, successively disposed below the lens, and contract or expand the area of the transforming layer based on the electric energy applied to the upper electrode layer and the lower electrode layer, and transform the shape of the lens correspondingly to the area of the contracted or expanded transforming layer.

Herein, the lens focus adjuster, in response to the electric energy being applied to the upper electrode layer and the lower electrode layer, may expand the area of the transforming layer correspondingly to the electric energy applied, and expand the lens correspondingly to the area of the expanded transforming layer, so as to transform the shape of the lens, and in response to the electric energy applied to the upper electrode layer and the lower electrode layer being reduced, may contract the area of the transforming layer correspondingly to the reduced electric energy, and contract the lens correspondingly to the area of the contracted transforming layer, so as to transform the shape of the lens.

Herein, the upper electrode layer and the lower electrode layer may include a transparent electrode.

Herein, the upper electrode layer may convert a portion of the electric energy applied into heat, and use the converted heat to transform the shape of the lens.

Herein, the transforming layer may include EAC (electro-active ceramic), SMA (shape memory alloy), or EAP (electro-active polymer).

Herein, the electro-active polymer may include ERF (electrorheological fluid), CNT (carbon nanotube), CP (conducting polymer), IPMC (ionic polymer metal composite), IPG (ionic polymer gel), LCE (liquid crystal elastomer), electro-viscoelastic elastomer, EP (dielectric elastomer), ferroelectric polymer, electrostrictive graft elastomer, or electrostrictive paper.

Herein, the transforming layer may have a gradient that gets thicker as it gets closer to its edge from the optical axis of the lens and vice versa.

Herein, the thickness of the transforming layer may be configured to be different depending on its location so as to prevent spherical aberration from occurring before and after the transformation. Herein, the tunable lens system may further include an electric energy supplier configured to apply electric energy to the lens focus adjuster.

If a flexible lens having one focal point is expanded, the focal length will also be elongated, but the focal point will be dispersed because the surface after expanded will not be a perfect parabola which is because the quantity of expansion will differ as its thickness. This problem can result in the blur effect of an image, which is called a spherical aberration in professional terminology. The lens focus adjuster compensates the spherical aberration based on a thickness varying with position to create one focal point.

According to the aforementioned various embodiments of the present invention, using a lens made of a solid material having high transparency and ductility, and a lens focus adjuster that has different thickness along with the position in order to avoid the spherical aberration even after being transformed, it is possible to always transform the surface of the lens in a parabolic shape and adjust the refractive index of the lens, thereby providing an effect of preventing the spherical aberration effect of blurring the focus of the lens.

Furthermore, since the lens is made of a transparent and flexible solid material, there is less risk of corrosion or short circuit of electric circuits even when the surface of the lens is torn, compared to the lens system using a liquid chamber for tunable lenses. Therefore the lens according to the present invention is highly applicable to the conventional electronic device.

Furthermore, since the lens is made of a transparent and flexible solid material, there is no need for a liquid injector, thereby providing the easiness of miniaturizing the tunable lens system and making the weight of the tunable lens system lighter.

Furthermore, since the shape of the lens may be transformed using electric energy, fast transformation of the lens is expected.

Furthermore, since the lens is made of a thermoplastic material, effective energy usage is possible because it is used only when transforming the shape of the lens, and no further energy is needed to maintain the state of the transformed shape of the lens. Therefore the lens is more energy-efficient than the conventional tunable lens system, since the conventional tunable lens system consumes energy not only when transforming the shape of the lens, but also when maintaining the transformed shape of the lens.

Furthermore, it is possible to miniaturize the lens system thanks to the simple structure of the lens system compared to the conventional tunable lens systems, since the new lens system does not require liquid injector or space around the lens. Therefore, a lens system may be applied to mobile phones or miniature cameras such as endoscopes that require zooming functions.

### BRIEF DESCRIPTION OF THE DRAWINGS

The above and other features and advantages of the present invention will become more apparent to those of ordinary skill in the art by describing in detail embodiments with reference to the attached drawings in which:

FIG. 1 is a cross-sectional view illustrating a tunable lens system according to an embodiment of the present invention;

FIG. 2(a), FIG. 2(b), FIG. 2(c) and FIG. 2(d) are cross-sectional views for explaining spherical aberration that may occur in a conventional tunable lens system;

FIG. 3(a) and FIG. 3(b) are cross-sectional views illustrating a method for adjusting the focal length by expanding the lens using a lens focus adjuster in a tunable lens system according to an embodiment of the present invention, wherein there are spherical aberration problemsssss with a constant thickness of a focus adjuster;

FIG. 4(a) and FIG. 4(b) are cross-sectional views illustrating a tunable lens system that includes a transforming layer having a gradient according to an embodiment of the present invention;

FIG. 5(a) and FIG. 5(b) are cross-sectional views illustrating some examples of a lens focus adjusters having various the gradient shapes of a transforming layer according to an embodiment of the present invention; and

FIG. 6(a) and FIG. 6(b) are cross-sectional views illustrating a lens focus adjuster for explaining a process of forming a gradient based on electric energy that is differently applied to different position on a transforming layer according to an embodiment of the present invention.

### DETAILED DESCRIPTION

Hereinafter, embodiments will be described in greater detail with reference to the accompanying drawings. Embodiments are described herein with reference to cross-sectional illustrates that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’, ‘second’, A, and B may be used to describe various components, but they should not limit the various components. Those terms are only used for the purpose of differentiating a component from other components. For example, a first component may be referred to as a second component, and a second component may be referred to as a first component and so forth without departing from the spirit and scope of the present invention. Furthermore, ‘and/or’ may include any one of or a combination of the components mentioned.

Furthermore, ‘connected’ represents that one component is directly connected to another component or indirectly connected through another component. In this specification, a singular form may include a plural form as long as it is not specifically mentioned in a sentence.

In this specification, a singular form may include a plural form as long as it is not specifically mentioned in a sentence. Furthermore, ‘include/comprise’ or ‘including/comprising’ used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

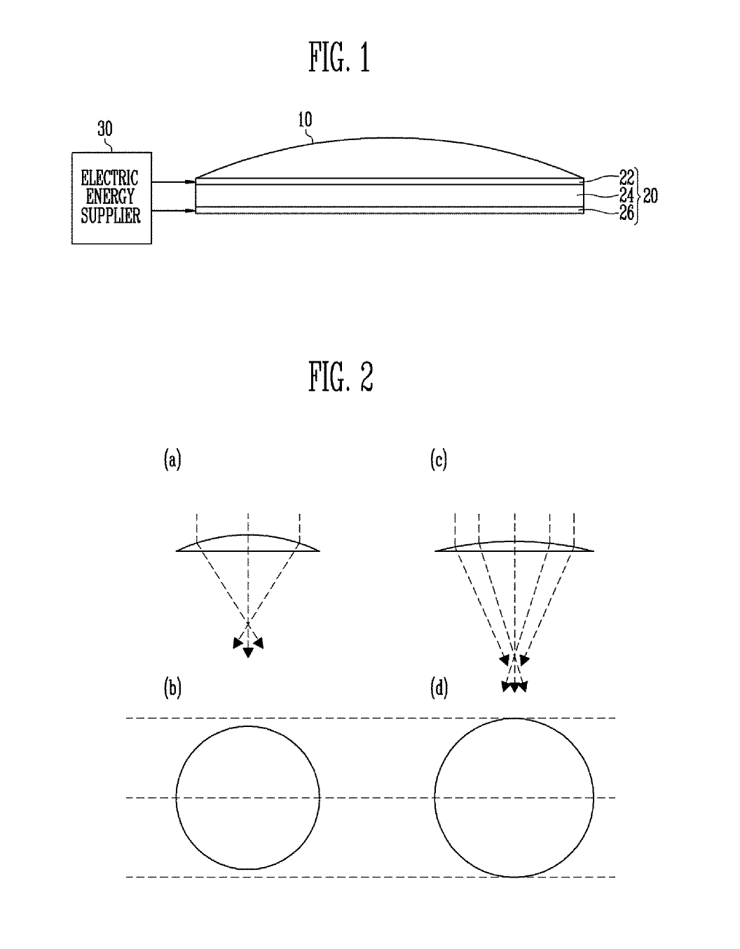

FIG. 1 is a cross-sectional view illustrating a tunable lens system according to an embodiment of the present invention.

Referring to FIG. 1, a tunable lens system according to an embodiment of the present invention includes a lens 10 and a lens focus adjuster 20. Furthermore, it may further include an electric energy supplier 30.

The lens 10 may include a transparent solid material.

Herein, the transparent solid material may include a flexible solid material.

Herein, the transparent solid material may include a thermoplastic material.

In one embodiment, thermoplasticity may refer to the property of being easily softened and thus transformed when it is heated, and easily hardening again when cooled. Therefore, a thermoplastic material may refer to a material having such thermoplasticity property.

In another embodiment, a thermoplastic material may include thermoplastic plastic or thermoplastic polymer.

In another embodiment, a thermoplastic material may include any one of PE (polyethylene), LDPE (low density polyethylene), LLDPE (linear low-density polyethylene), HDPE (high density polyethylene), UHMWPE (ultra high molecular weight density polyethylene), EVA (ethylenevinylacetate), EVOH (ethylenevinylalcohol), ionomer, PVC (polyvinylchloride), PVDC (Polyvinylidenechloride), PVF (polyvinylidenefluoride), CPVC (chlorinated polyvinylchloride), PVAc (Polyvinylacetate), PVA (polyvinylalcohol), PVB (polyvinyl), PMMA (poly(methyl methacrylate)), PS (polystyrene), ABS (acrylonitrilebutadienestyrene), and acryl.

As aforementioned, in a tunable lens system according to an embodiment of the present invention, the lens may be made of a transparent and flexible solid material.

Therefore, compared to a conventional tunable lens system wherein if the surface of the tunable lens is torn, the liquid inside the tunable lens may leak, and the leaked liquid may cause corrosion or short circuit to the electric circuits near the tunable lens, or adversely affect human bodies, in a tunable lens system according to an embodiment of the present invention, since the lens is made of a transparent and flexible solid material, there is no risk of corrosion or short circuit of electric circuits even when the surface of the lens is torn, thereby providing an effect of increased degree of integration with the electric circuits, and preventing the lens from having an adverse effect on human bodies.

Furthermore, compared to a conventional lens system wherein a liquid injector or an injection pipe for injecting the liquid may be disposed near the tunable lens, thereby making it is hard to miniaturize the tunable lens system, in a tunable lens system according to an embodiment of the present invention, since the lens is made of a transparent and flexible solid material, there is no need for a liquid injector or an injection pipe, thereby providing an effect of miniaturizing the tunable lens system and making the weight of the tunable lens system lighter.

As aforementioned, a tunable lens system according to an embodiment of the present invention may be made of a thermoplastic material.

Therefore, compared to a conventional lens system that uses a liquid-injected lens that requires energy to transform the shape of the lens and the maintain the transformed state of the lens, in a tunable lens system according to an embodiment of the present invention, since the lens is made of a thermoplastic material, effective energy usage is possible because it is used only when transforming the shape of the lens, and no further energy is needed to maintain the transformed state of the lens. Therefore the lens system according to an embodiment of the present invention is more energy-efficient than the conventional tunable lens system, since the conventional tunable lens system consumes energy not only when transforming the shape of the lens, but also when maintaining the transformed shape of the lens.

The lens focus adjuster 20 may be disposed below the lens 10. Furthermore, the lens focus adjuster 20 may be connected to the electric energy supplier 30. Furthermore, the lens focus adjuster 20 may be applied with electric energy from the electric energy supplier 30.

Furthermore, the lens focus adjuster 20 may contract or expand its area based on the electric energy applied, and transform the shape of the lens correspondingly to the contracted or expanded area so as to adjust the focal length of the lens 10.

Herein, the transformed lens may not have a parabolic shaped surface that generates spherical aberration, if the thickness of a focus adjuster 20 is constant.

Herein, contraction of area may mean reduction in the planar direction.

Herein, expansion of area may mean increase in the planar direction.

That is, the lens focus adjuster 20 may be the main subject that transforms the shape of the lens 10. In other words, the lens focus adjuster 20 that includes a transparent and flexible material may change its thickness based on the electric energy applied, and contract or expand the area correspondingly to the changed thickness.

Therefore, the lens 10 that is disposed above the lens focus adjuster 20 may contract its area correspondingly to the area of the contracted lens focus adjuster 20. Furthermore, the lens 10 that is disposed above the lens focus adjuster 20 may expand its area correspondingly to the area of the expanded lens focus adjuster 20.

As aforementioned, a tunable lens system according to an embodiment of the present invention may transform the shape of the lens by transforming the shape of the lens focus adjuster 20 that contracts or expands its area based on the electric energy applied.

Therefore, compared to a conventional tunable lens system that transforms the shape of the lens by injecting liquid, a tunable lens system according to an embodiment of the present invention may transform the shape of the lens at high speed by transforming the shape of the lens based on the electric energy applied.

Furthermore, compared to another conventional tunable lens system which is provided with pressure to the verge of a lens in order to make its shape at center transformed, a tunable lens system according to an embodiment of the present invention doesn't need space around the lens since a focus adjuster layer transforms the shape of the lens by transforming the shape of the lens focus adjuster, thereby miniaturizing the tunable lens system and making it lighter and simpler.

Furthermore, the lens focus adjuster 20 may include an upper electrode layer 22, transforming layer 24, and lower electrode layer 26. That is, the lens focus adjuster 20 may successively include an upper electrode layer 22, transforming layer 24, and lower electrode layer 26 below the lens 10.

Furthermore, the lens focus adjuster 20 may contract or expand the area of the transforming layer 24 in the planar direction based on the electric energy applied to the upper electrode layer 22 and the lower electrode layer 26, and transform the shape of the lens 10 correspondingly to the area of the contracted or expanded transforming layer 24 in the planar direction.

Herein, when the electric energy is applied to the upper electrode layer 22 and the lower electrode layer 26, the lens focus adjuster 20 may expand the area of the transforming layer 24 in the planar direction correspondingly to the electric energy applied, and transform the shape of the lens 10 correspondingly to the area of the expanded transforming layer 24 in the planar direction.

That is, when the electric energy is applied to the upper electrode layer 22 and the lower electrode layer 26, the thickness of the transforming layer 24 gets thinner correspondingly to the electric energy applied, the area of the transforming layer 24 expands in the planar direction correspondingly to the reduced thickness of the transforming layer 24, the area of the upper electrode layer 22 and the lower electrode layer 26 expands correspondingly to the area of the expanded transforming layer 24, and the lens 10 expands correspondingly to the expanded upper electrode layer 22, thereby transforming the shape of the lens 10.

Herein, when the electric energy applied to the upper electrode layer 22 and the lower electrode layer 26 is reduced, the lens focus adjuster 20 may contract the area of the transforming layer 24 in the planar direction correspondingly to the reduced electric energy, and contract the lens 10 correspondingly to the contracted transforming layer 24, thereby transforming the shape of the lens 10.

That is, when the electric energy applied to the upper electrode layer 22 and the lower electrode layer 26 is reduced, the lens focus adjuster 20 may expand the thickness of the transforming layer 24 correspondingly to the electric energy reduced, contract the area of the transforming layer 24 in the planar direction correspondingly to the thickness of the expanded transforming layer 24, contract the area of the upper electrode layer 22 and the lower electrode layer 26 correspondingly to the area of the contracted transforming layer 24, and contract the lens 10 correspondingly to the area of the contracted upper electrode layer 22, thereby transforming the shape of the lens 10.

The upper electrode layer 22 and the lower electrode layer 26 may be disposed below the lens 10. Herein, the upper electrode layer 22 may be disposed below the lens 10, and the transforming layer 24 may be disposed between the upper electrode layer 22 and the lower electrode layer 26.

Furthermore, the upper electrode layer 22 and the lower electrode layer 26 may be connected to the electric energy supplier 30. Furthermore, the upper electrode layer 22 and the lower electrode layer 26 may be applied with at least one electric energy from the electric energy supplier 30.

Herein, the upper electrode layer 22 and the lower electrode layer 26 may be applied with the same electric energy from the electric energy supplier 30.

Herein, the upper electrode layer 22 and the lower electrode layer 26 may be applied with different electric energies from an electric energy supplier 30.

Herein, the upper electrode layer 22 and the lower electrode layer 26 may be applied with a plurality of electric energies having a constant intensity from the electric energy supplier 30.

Herein, the upper electrode layer 22 and the lower electrode layer 26 may be provided at least one electric energy from the electric energy supplier 30 to transform the transforming layer 24.

Furthermore, the upper electrode layer 22 and the lower electrode layer 26 may include a flexible material.

Herein, as the upper electrode layer 22 and the lower electrode layer 26 include a flexible material, when the area of the transforming layer 24 disposed between the upper electrode layer 22 and the lower electrode layer 26 either contracts or expands, the area of the upper electrode layer 22 and the lower electrode layer 26 may contract or expand correspondingly.

Furthermore, the upper electrode layer 22 and the lower electrode layer 26 may include a transparent material.

Furthermore, the upper electrode layer 22 and the lower electrode layer 26 may include one or more electrodes. In an embodiment, the upper electrode layer 22 and the lower electrode layer 26 may be configured as one electrode. In another embodiment, the upper electrode layer 22 and the lower electrode layer 26 may be configured as a plurality of electrodes.

Furthermore, the upper electrode layer 22 and the lower electrode layer 26 may include a transparent electrode.

Herein, the transparent electrode may include an oxide transparent electrode, carbohydrate transparent electrode, metal type transparent electrode, or hybrid type transparent electrode.

Herein, the transparent electrode may include an ITO (indium tin oxide) transparent electrode, Zno (zinc oxide) transparent electrode, SnO₂ (tin oxide) transparent electrode, high molecular transparent electrode (for example, PEDOT:PSS(poly(3,4-ethylene dioxythiophene):poly(styrene sulfonate) transparent electrode), CNT (carbon nano tube) transparent electrode, grapheme transparent electrode, silver nanowire transparent electrode, or multilayer structure transparent electrode.

Furthermore, the upper electrode layer 22 may convert a portion of the electric energy applied from the electric energy supplier 30 into heat. That is, it may convert a portion of the electric energy applied into heat, and use the converted heat to efficiently transform the shape of the lens 10 that includes a transparent solid material.

Especially, the upper electrode layer 22 may include a heating plate. Herein, the heating plate is a device capable of converting a portion of the electric energy applied into heat, and the heating plate may have functions of an electrode. Herein, the heating plate may convert a portion of the electric energy into heat, and use the converted heat to transform the shape of the lens 10 that includes a transparent solid material. Herein, the heating plate may include a transparent and flexible material.

Therefore, in the case where the lens includes the aforementioned thermoplastic material, it is possible to form the upper electrode layer as heating plate, thereby simplifying the structure of the tunable lens system according to an embodiment of the present invention.

The transforming layer 24 may be disposed between the upper electrode layer 22 and the lower electrode layer 26. Furthermore, the area of the transforming layer 24 may contract or expand in the planar direction based on the electric energy applied to the upper electrode layer 22 and the lower electrode layer 26.

Furthermore, the transforming layer 24 may include a transparent and flexible material.

Furthermore, the transforming layer 24 may include EAC (electro-active ceramic), SMA (shape memory alloy), or EAP (electro-active polymer).

The SMA (shape memory alloy) may refer to an alloy that may be transformed by heat back to the previous shape before it was transformed even after it has been transformed into a different shape.

Furthermore, the SMA (shape memory alloy) may include Ni—Ti (Nickel-Titan) shape memory alloy, Cu—Zn (Copper-Zinc) shape memory alloy, Cu—Zn—Al (Copper-Zinc-Aluminum) shape memory alloy, Cu—Cd (Copper-Cadmium) shape memory alloy, or Ni—Al (Nickel-Aluminum) shape memory alloy.

Electro active polymer may refer to a type of functional polymer that causes mechanical transformation by movement and diffusion or electrostatic force of an ion when electric energy is applied, but causes electric energy when a mechanical transformation is made.

Furthermore, the electro active polymer may include ionic EAP (electro active polymer) or electronic EAP.

Herein, the ionic electro active polymer may refer to a polymer that causes contraction or expansion by movement and diffusion of an ion when electric energy is applied. Furthermore, the ionic electro active polymer may include ERF (electrorheological fluid), CNT (carbon nanotube), CP (conducting polymer), IPMC (ionic polymer metal composite), or IPG (ionic polymer gel).

Herein, the electronic EAP may refer to a polymer that causes contraction or expansion due to electronic polarization when electric energy is applied. Furthermore, the electronic EAP may include LCE (liquid crystal elastomer), electro-viscoelastic elastomer, EP (dielectric elastomer), ferroelectric polymer, electrostrictive graft elastomer, or electrostrictive paper.

Furthermore, the EAP may include a dielectric substance that may deliver the polarity of electricity but not an electron.

Therefore, the lens focus adjuster 20 according to an embodiment of the present invention may include an upper electrode layer 22, a transforming layer 24 that includes EAP having a dielectric substance, and a lower electrode layer 26.

Herein, when electric energy is applied to the upper electrode layer 22 and lower electrode layer 26, an electric field may be formed on the transforming layer 24 that includes EAP having a dielectric substance, and the area of the transforming layer 24 may contract or expand correspondingly to the intensity of the electric field formed.

That is, the higher the intensity of the electric field formed, the higher pressing force is generated in the direction of the electric field. Accordingly, by the pressing force that gradually gets higher, that is by the upper electrode layer 22 and the lower electrode layer 26, the transforming layer 24 is pressed and thus its thickness contracts, and the area may gradually expand in the planar direction correspondingly to the contracted thickness.

Then, the lower the intensity of the electric field formed, the higher the thickness of the expanded transforming layer 24, and the area may gradually contract correspondingly to the expanded thickness.

Furthermore, the transforming layer 24 may have a gradient.

In an embodiment, the gradient of the transforming layer 24 may have a predetermined shape. In another embodiment, the shape of the gradient of the transforming layer 24 may be determined based on a plurality of electric energies having different intensities applied to the upper electrode layer 22 and the lower electrode layer 26. That is, the shape of the gradient of the transforming layer 24 may be determined according to the intensity of the electric field per unit of area or the distribution thereof generated correspondingly to the plurality of electric energies having different intensities applied to the upper electrode layer 22 and the lower electrode layer 26.

Herein, the gradient of the transforming layer 24 may be one that gets thicker as it gets closer to the edge from the optical axis of the lens 10 or vice versa.

Herein, the gradient of the transforming layer 24 may include a gradient of a straight line or a gradient of a curved line.

A tunable lens system according to an embodiment of the present invention may further include an electric energy supplier 30.

The electric energy supplier 30 is a device or circuit for supplying at least one electric energy to the lens focus adjuster 20, and it is not limited a particular configuration.

Herein, electric energy may include a voltage or current.

Furthermore, the electric energy supplier 30 may be connected to a power source. Furthermore, the electric energy supplier 30 may receive alternating current power source or direct power current power source from the power source. Furthermore, the electric energy supplier 30 may generate at least one electric energy correspondingly to the alternating current power source or direct current power source applied. Furthermore, the electric energy supplier 30 may apply at least one electric energy generated to the lens focus adjuster 20.

Especially, the electric energy supplier 30 may apply at least one electric energy generated to the upper electrode layer 22 and lower electric layer 26 of the lens focus adjuster 20.

Herein, the electric energy supplier 30 may apply the same electric energy to the upper electrode layer 22 and the lower electrode layer 26.

Herein, the electric energy supplier 30 may apply different electric energies to the upper electrode layer 22 and the lower electrode layer 26.

Herein, the electric energy supplier 30 may apply a plurality of electric energies having a constant intensity to the upper electrode layer 22 and the lower electrode layer 26.

Herein, the electric energy supplier 30 may apply a plurality of electric energies having different intensities to the upper electrode layer 22 and the lower electrode layer 26.

Furthermore, the electric energy supplier 30 may include a power source controller and power source converter.

The power source controller may generate a control signal for controlling the power source converter. Furthermore, the power source controller may provide the control signal generated to the power source converter.

The power source converter may be connected to a power source. Herein, the power source converter may be applied with alternating current power source or direct current power source from the power source. Furthermore, the power source converter may be connected to the power source controller. Herein, the power source converter may receive a control signal from the power source controller.

Furthermore, the power source converter may perform power source conversion on the alternating current power source or direct current power source correspondingly to the control signal of the power source controller. Furthermore, the power source converter may generate at least one electric energy correspondingly to the power source converted. Furthermore, the power source converter may apply the at least one energy generated to the upper electrode layer 22 and power electrode layer 26 of the lens focus adjuster 20.

Herein, in the case where the power source is a direct current power source, the power source converter may include a DC-DC converter (direct current-direct current converter) or a DC-AC converter (direct current-alternating current converter).

That is, the power source converter may convert a direct current power source into a direct current power source or alternating power source using a DC-DC converter or DC-AC converter that operates correspondingly to the control signal of the power source controller, and generate at least one electric energy that corresponds to the converted power source.

Herein, in the case where the power source is an alternating power source, the power source converter may include an AC-DC converter (alternating current-direct current converter) or AC-AC converter (alternating current-alternating current converter).

That is, the power source converter may convert an alternating current power source into a direct current power source or alternating current power source using an AC-DC converter or AC-AC converter that operates correspondingly to the control signal of the power source controller, and generate at least one electric energy that corresponds to the converted power source.

Furthermore, the power source converter may apply the at least one electric energy generated to the upper electrode layer 22 and the lower electrode layer 26 of the lens focus adjuster 20.

Herein, the power source converter may apply the same electric energy to the upper electrode layer 22 and the lower electrode layer 26.

Herein, the power source converter may apply different electric energies to the upper electrode layer 22 and the lower electrode layer 26.

Herein, the power source converter may apply a plurality of electric energies having a constant intensity to the upper electrode layer 22 and the lower electrode layer 26.

Herein, the power source converter may apply a plurality of electric energies having different intensities to the upper electrode layer 22 and the lower electrode layer 26.

FIG. 2(a) and FIG. 2(b) are cross-sectional views for explaining spherical aberration that may occur in conventional tunable lenses system.

Referring to FIG. 2(a) and FIG. 2(b), FIG. 2(a) is a cross-sectional view illustrating the shape of a lens before it is transformed in a conventional tunable lens system, and FIG. 2(b) is a plane view of the lens illustrated in FIG. 2(a). FIG. 2(c) is a cross-sectional view illustrating the shape of a transformed lens, that is an expanded lens, and FIG. 2(d) illustrates a plane view of the lens illustrated in FIG. 2(c).

In a conventional lens system where a lens is expanded by a constant energy, when the lens extends in the planar direction and its thickness contracts from FIG. 2(a) to FIG. 2(c), the area of the lens may expand from FIG. 2(b) to FIG. 2(d) correspondingly to the thickness of the lens. When the lens which has a perfect parabolic shape FIG. 2(a) is pulled with a predetermined force in the planar shape, the lens is extended FIG. 2(c). However, the surface of the extended lens may not have the parabolic shape since difference in stress is caused by the difference in thickness of the lens even when the same amount of force is evenly applied to the lens. In other words, the difference in stress results in the relatively thin edge of the lens extending more than the relatively thick central portion thereof. As a result, the parabolic shape may not be maintained.

Therefore, in such a conventional tunable lens system, when the area increases from FIG. 2(b) to FIG. 2(d) in the planar direction, the light that enters the lens does not gather at one point, and thus the focus of the lens may blur, thereby causing spherical aberration.

FIG. 3(a) and FIG. 3(b) are cross-sectional views illustrating a tunable lens with a focus adjuster without considering a spherical aberration problem. When the focus adjuster expands in the planar direction, the focal length becomes longer, but the aberration problem is unavoidable.

Referring to FIG. 3(a) and FIG. 3(b), a tunable lens system according to an embodiment of the present invention may include a lens 10 and a lens focus adjuster 20.

Herein, the lens 10 may include a thermoplastic material.

Herein, the lens focus adjuster 20 may include a flexible and transparent material that is capable of performing the functions of a lens.

Herein, a transforming layer 24 of the lens focus adjuster 20 may include an electro active polymer made of dielectric substance.

Referring to FIG. 3(a) and FIG. 3(b), FIG. 3(a) is a cross-sectional view illustrating the shape of a tunable lens system according to an embodiment of the present invention before it was transformed, and FIG. 3(b) is a cross-sectional view of a tunable lens system according to an embodiment of the present invention that has been transformed, that is an expanded lens.

When electric energy is applied to the upper electrode layer 22 and lower electrode layer 26, on the transforming layer 24, that is disposed between the upper electrode layer 22 and the lower electrode layer 26, an electric field may be generated correspondingly to the electric energy applied.

Herein, as illustrated in FIG. 3(a) and FIG. 3(b), by the electric field generated on the transforming layer 24, the thickness is contracted to FIG. 3(a) to FIG. 3(b), and the area may expand in the planar direction correspondingly to the contracted thickness.

Herein, the area of the lens 10 may expand correspondingly to the area of the expanded transforming layer 24, and when the expanding is finished, the lens may harden for itself due to the characteristics of the thermoplastic material. Herein, the shape of the lens 10 that finished expanding may not have a parabolic surface if the thickness of expanded the focus adjuster is constant.

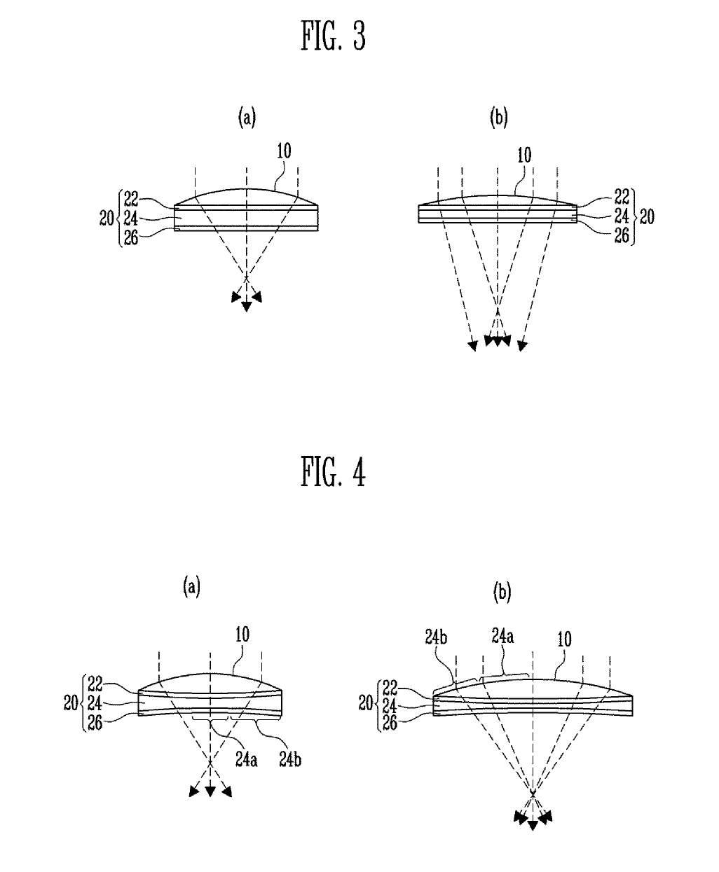

FIG. 4(a) and FIG. 4(b) are cross-sectional views illustrating a tunable lens system that includes a transforming layer having a gradient in order to clear a spherical aberration problem in FIG. 3(a) and FIG. 3(b) according to an embodiment of the present invention.

Referring to FIG. 4(a) and FIG. 4(b), a tunable lens system according to an embodiment of the present invention may include a transforming layer 24 having a gradient. Herein, the transforming layer 24 may have a gradient of which the thickness gets thicker as it gets closer to the edge from the optical axis of the lens 10.

Herein, a tunable lens system that includes a transforming layer 24 having a gradient according to an embodiment of the present invention is similar to the tunable lens system according to an embodiment of the present invention explained with reference to FIG. 1 and FIG. 3, besides the features that will be explained herein below.

Referring to FIG. 4(a) and FIG. 4(b), FIG. 4(a) is a cross-sectional view illustrating the shape of a tunable lens system including a transforming layer 24 having a gradient before it was transformed, and FIG. 4(b) is a cross-sectional view of a tunable lens system including a transforming layer 24 having a gradient according to an embodiment of the present invention that has been transformed, that is the shape after expanding.

As illustrated in FIG. 4(a), the transforming layer 24 according to an embodiment of the present invention may be configured such that the thickness of the optical axis portion 24a of the lens 10 is thin, and the thickness getting thicker as it gets closer to the edge 24b from the optical axis of the lens.

Herein, even when constant electric energy is applied to the upper electrode layer 22 and lower electrode layer 26, as illustrated in FIG. 4(b), the area of the center part 24a of the lens may expand relatively more than the area of the edge part 24b of the lens, because close distance between the two electrodes produces high power to expand. Therefore, relatively less expanded area, which is the edge of the lens, create relatively higher refraction angle so that dispersed lights passing through the lens can gather at one focal point.

FIG. 5(a) and FIG. 5(b) are cross-sectional views illustrating a lens focus adjuster including the gradient shapes of a transforming layer according to an embodiment of the present invention.

Referring to FIG. 5(a) and FIG. 5(b), FIG. 5(a) is a cross-sectional view illustrating a lens focus adjuster 20 including a transforming layer 24 having a gradient of a straight line, and FIG. 5(b) is a cross-sectional view illustrating a lens focus adjuster 20 including a transforming layer 24 having a gradient of a curved line.

Especially, as illustrated in FIG. 5(a) and FIG. 5(b), the shape of the gradient of the transforming layer 24 may include a gradient of a straight line or curved line, but is not limited thereto as long as the thickness of the lens of the transforming layer 24 gets thicker as it gets closer to the edge from the optical axis.

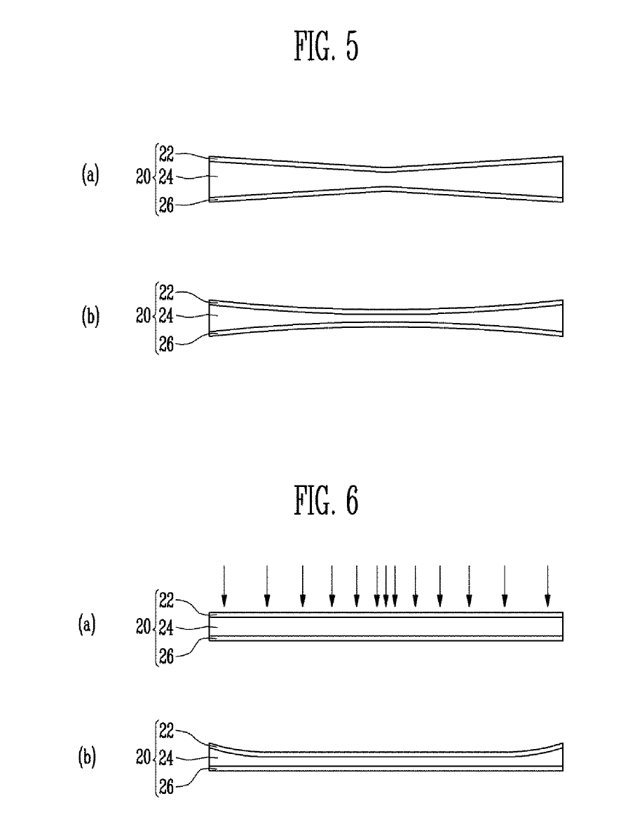

FIG. 6(a) and FIG. 6(b) are a cross-sectional view illustrating a lens focus adjuster for explaining a process of forming a gradient based on electric energy gradiently applied to a transforming layer along with the position according to an embodiment of the present invention.

Referring to FIG. 6(a) and FIG. 6(b), FIG. 6(a) is a cross-sectional view illustrating a lens focus adjuster before electric energy is applied, that is a lens focus adjuster including a transforming layer that does not have a gradient, and FIG. 6(b) is a cross-sectional view illustrating a lens focus adjuster after electric energy is applied, where its intensity is gradiently applied to a transforming layer along with the position, that is a lens focus adjuster after electric energy has been applied, that is a lens focus adjuster including a transforming layer that has a gradient. Furthermore, the number of arrows per equally divided area illustrated in FIG. 6(a) may indicate the direction, the intensity or the magnitude of electric field.

By controlling the intensity or distribution per area of the electric field generated correspondingly to a plurality of electric energies having different intensities applied to the upper electrode layer 22 and lower electrode layer 24, it is possible to change the transforming layer 24 that does not have a gradient as illustrated in FIG. 6(a) into a gradient as illustrated in FIG. 6(b).

That is, by applying a weaker electric field to the edge of the lens than the optical axis portion of the lens in the transforming layer 24, the transforming layer 24 may have a gradient that gets thicker as it gets closer to the edge from the optical axis of the lens as illustrated in FIG. 6(b).

Therefore, in a tunable lens system according to an embodiment of the present invention, there is a provided lens having a transforming layer having a gradient that gets thicker as it gets closer to the edge from the optical axis of the lens, and thus by adjusting bending of lights entering the lens to make them focus at one point, thus it is possible to improve the spherical aberration that occurs when the lens is transformed and the bending of the light entering the edge of the lens gets weak.

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A tunable lens system comprising:
a lens including a transparent solid material; and
a lens focus adjuster disposed below the lens, and configured such that its area contracts or expands based on the electric energy applied and transforms the shape of the lens correspondingly to the contracted or expanded area so as to adjust the focus of the lens.

2. The tunable lens system according to claim 1,
wherein the transparent solid material comprises a thermoplastic material.

3. The tunable lens system according to claim 1,
wherein the transformed lens has a parabolic shape with the help of a lens focus adjuster.

4. The tunable lens system according to claim 1,
wherein the lens focus adjuster comprises an upper electrode layer, transforming layer, and lower electrode layer, successively disposed below the lens, and
contracts or expands the area of the transforming layer based on the electric energy applied to the upper electrode layer and the lower electrode layer, and transforms the shape of the lens correspondingly to the area of the contracted or expanded transforming layer.

5. The tunable lens system according to claim 4,
wherein the lens focus adjuster, in response to the electric energy being applied to the upper electrode layer and the lower electrode layer, expands the area of the transforming layer correspondingly to the electric energy applied, and expands the lens correspondingly to the area of the expanded transforming layer, so as to transform the shape of the lens, and
in response to the electric energy applied to the upper electrode layer and the lower electrode layer being reduced, contracts the area of the transforming layer correspondingly to the reduced electric energy, and contracts the lens correspondingly to the area of the contracted transforming layer, so as to transform the shape of the lens.

6. The tunable lens system according to claim 4,
wherein the upper electrode layer and the lower electrode layer comprise a transparent electrode.

7. The tunable lens system according to claim 4,
wherein the upper electrode layer converts a portion of the electric energy applied into heat, and uses the converted heat to transform the shape of the lens.

8. The tunable lens system according to claim 4,
wherein the transforming layer comprises EAC (electro-active ceramic), SMA (shape memory alloy), or EAP (electro-active polymer).

9. The tunable lens system according to claim 8,
wherein the electro-active polymer comprises ERF (electrorheological fluid), CNT (carbon nanotube), CP (conducting polymer), IPMC (ionic polymer metal composite), IPG (ionic polymer gel), LCE (liquid crystal elastomer), electro-viscoelastic elastomer, EP (dielectric elastomer), ferroelectric polymer, electrostrictive graft elastomer, or electrostrictive paper.

10. The tunable lens system according to claim 4,
wherein the transforming layer has a gradient that gets thicker as it gets closer to its edge from the optical axis of the lens.

11. The tunable lens system according to claim 4,
wherein the thickness of the transforming layer is configured to be different depending on its location so as to prevent spherical aberration from occurring due to inconsistent or unexpected transformation of the lens.

12. The tunable lens system according to claim 1,
wherein the tunable lens system further comprises an electric energy supplier configured to apply electric energy to the lens focus adjuster.
